(19) United States
(12) Patent Application Publication
(10) Pub. No.: US 2025/0103898 A1
(43) Pub. Date: Mar. 27, 2025

(54) ENERGY-EFFICIENT ANOMALY DETECTION AND INFERENCE ON EMBEDDED SYSTEMS

(71) Applicant: QUALCOMM Incorporated, San Diego, CA (US)

(72) Inventor: Haijun ZHAO, Beijing (CN)

(21) Appl. No.: 18/729,859

(22) PCT Filed: Mar. 21, 2022
(86) PCT No.: PCT/CN2022/081923

§ 371 Date: Jul. 17, 2024

(51) Int. Cl. G06N 3/096; G06N 3/0455

(52) U.S. Cl. CPC G06N 3/096; G06N 3/0455

(57) ABSTRACT

A method of anomaly detection and energy-efficient inference determination includes receiving an input. A set of features of the input are extracted using an artificial neural network (ANN) to generate a latent representation of the input. A reconstruction of the input is generated using the ANN, based on the latent representation. A reconstruction error is computed based on the generated reconstruction and the input. The reconstruction error is compared to a predefined threshold to determine whether the in-distribution data or out-of-distribution data. An anomaly is detected in response to an out-of-distribution determination. A decision model is provided with the latent representation in response to the input being determined to be in-distribution data. In turn, the decision model computes an inference based on the latent representation.

### FIELD OF THE DISCLOSURE

Aspects of the present disclosure generally relate to neural networks.

### BACKGROUND

Artificial neural networks may comprise interconnected groups of artificial neurons (e.g., neuron models). The artificial neural network may be a computational device or represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, pattern recognition, speech recognition, autonomous driving, and other classification tasks.

### SUMMARY

The present disclosure is set forth in the independent claims, respectively. Some aspects of the disclosure are described in the dependent claims.

In an aspect of the present disclosure, a method for anomaly detection and inference is provided. The method includes receiving an input. The method also includes extracting, using an artificial neural network (ANN), a set of features of the input to generate a latent representation of the input. Additionally, the method includes generating, using the ANN, a reconstruction of the input based on the latent representation. Further, the method includes determining a reconstruction error based on the generated reconstruction and the input. The method also includes determining whether the input comprises in-distribution data or out-of-distribution data based on a comparison of the reconstruction error and a predefined threshold. Furthermore, the method includes detecting an anomaly responsive to the input being determined to comprise out-of-distribution data.

In an aspect of the present disclosure, an apparatus for anomaly detection and inference is provided. The apparatus includes a memory and one or more processors coupled to the memory. The processor(s) are configured to receive an input. The processor(s) are also configured to extract, using an artificial neural network (ANN), a set of features of the input to generate a latent representation of the input. In addition, the processor(s) are configured to generate, using the ANN, a reconstruction of the input based on the latent representation. Further, the processor(s) are configured to determine a reconstruction error based on the generated reconstruction and the input. The processor(s) are also configured to determine whether the input comprises an anomaly or in-distribution data based on a comparison of the reconstruction error and a predefined threshold. Furthermore, the processor(s) are configured to detect an anomaly responsive to the input being determined to comprise out-of-distribution data.

In an aspect of the present disclosure, an apparatus for anomaly detection and inference is provided. The apparatus includes means for receiving an input. The apparatus also includes means for extracting, using an artificial neural network (ANN), a set of features of the input to generate a latent representation of the input. Additionally, the apparatus includes means for generating, using the ANN, a reconstruction of the input based on the latent representation. Further, the apparatus includes means for determine a reconstruction error based on the generated reconstruction and the input. The apparatus also includes means for determining whether the input comprises an anomaly or in-distribution data based on a comparison of the reconstruction error and a predefined threshold. Furthermore, the apparatus includes means for detecting an anomaly responsive to the input being determined to comprise out-of-distribution data.

In an aspect of the present disclosure, a non-transitory computer readable medium is provided. The computer readable medium has encoded thereon program code for anomaly detection and inference. The program code is executed by a processor and includes code to receive an input. The program code also includes code to extract, using an artificial neural network (ANN), a set of features of the input to generate a latent representation of the input. Additionally, the program code includes code to generate, using the ANN, a reconstruction of the input based on the latent representation. Further, the program code includes code to determine a reconstruction error based on the generated reconstruction and the input. The program code also includes code to determine whether the input comprises an anomaly or in-distribution data based on a comparison of the reconstruction error and a predefined threshold. Furthermore, the program code includes code to detect an anomaly responsive to the input being determined to comprise out-of-distribution data.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating an example architecture for an anomaly detection and decision model, in accordance with aspects of the present disclosure.

FIG. 6 is a diagram illustrating another example architecture for an anomaly detection and decision model, in accordance with aspects of the present disclosure.

FIG. 7 is a flow diagram illustrating a method of anomaly detection and energy-efficient inference determination, according to aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Artificial neural networks have grown in popularity because of their ability to solve complex problems. Artificial neural network architectures are used in various technologies, such as image recognition, pattern recognition, speech recognition, autonomous driving, and other classification tasks. However, for many such applications, much of the data may be unlabeled. Furthermore, the unlabeled data may be available in large amounts such as for example in a video surveillance system.

The large quantity of unlabeled data may present a significant challenge for supervised learning. This is in part because there are a large number of positive examples available to learn, but relatively few examples of abnormal or negative examples. For example, in autonomous driving systems, the vast majority of training data may be composed of standard vehicles. However, it may also be desirable for neural network models to recognize some rarely observed classes of vehicles, such as emergency vehicles or objects that are not vehicles (e.g., animals). Thus, such systems may have imbalanced data.

Imbalanced data may refer to an unequal distribution of classes in a training dataset (e.g., substantially more standard vehicles than emergency vehicles). Classification systems with imbalanced data may generate incorrect decisions as the classification may be skewed toward a standard vehicle. Moreover, such incorrect decisions may have significant costs. For example, in a fraud detection system, misidentification of a fraudulent transaction may result in significant financial loss and disruption of financial services. In another example, in a medical diagnostic system, classification of an abnormal sinus rhythm as normal may result in an undetected heart attack and significant health consequences.

In addition, machine learning performance may be significantly lower than reported research results. This may be due to the assumption that the test data comes from the same distribution as the training data. However, in practice, such systems may encounter data that is out-of-distribution. In such cases, a softmax function of a classifier may not provide confidence information to identify whether data is in-distribution or out-of-distribution.

Aspects of the present disclosure are directed to anomaly detection. An anomaly refers to an item or event that does not conform to an expected pattern or other items in a dataset that may be undetectable. In accordance with aspects of the present disclosure, the model may detect test samples that are out-of-distribution. For example, the model may detect if a test sample is drawn sufficiently far away from the training distribution by unlabeled data. The model may also include an autoencoder. The model may determine an anomaly score based on the reconstruction error of the autoencoder. For instance, the reconstruction error may be compared to a threshold and an anomaly may be determined if the reconstruction error exceeds the threshold. In some aspects, the threshold may be selected from multiple thresholds.

In other aspects, the autoencoder may be implemented with tied weights. That is, weights of an encoder of the autoencoder may be matched with the weight parameters of the decoder. Because the weights are the same, the memory footprint for the autoencoder may be reduced (e.g., cut in half).

Furthermore, in some aspects, the encoder may serve as a feature extractor for a next stage decision among in-distribution data.

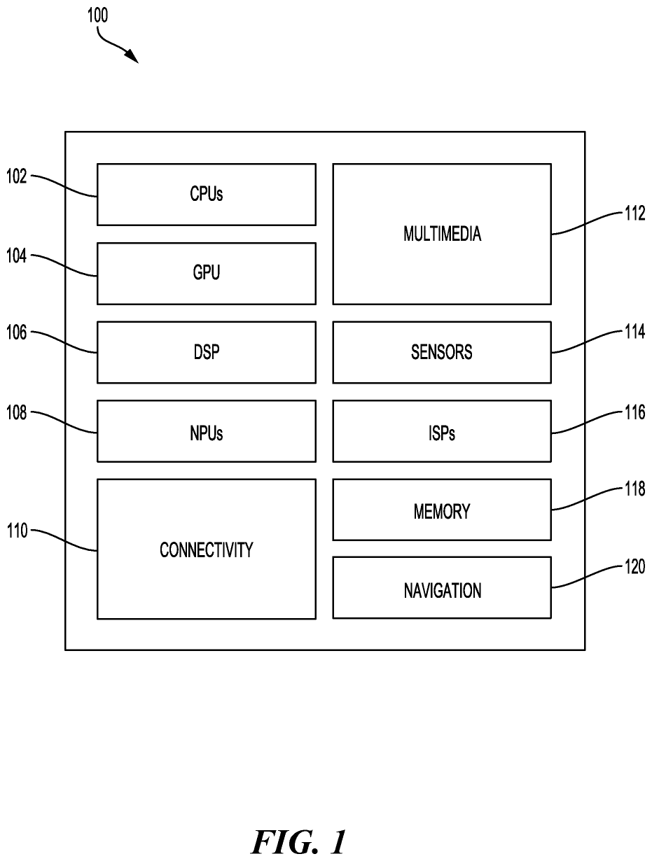

FIG. 1 illustrates an example implementation of a system-on-a-chip (SoC) 100, which may include a central processing unit (CPU) 102 or a multi-core CPU configured to detect an anomaly and efficiently determine inferences in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SoC 100 may also include a sensor processor 114, image signal processors (ISPs) 116, and/or navigation module 120, which may include a global positioning system.

The SoC 100 may be based on an ARM instruction set. In aspects of the present disclosure, the instructions loaded into the CPU 102 may comprise code to receive an input. The instructions loaded into the CPU 102 may also comprise code to extract, using an artificial neural network (ANN), a set of features of the input to generate a latent representation of the input. The instructions loaded into the CPU 102 may additionally comprise code to generate, using the ANN, a reconstruction of the input based on the latent representation. The instructions loaded into the CPU 102 may further comprise code to determine a reconstruction error based on the generated reconstruction and the input. The instructions loaded into the CPU 102 may also comprise code to determine whether the input comprises in-distribution data or out-of-distribution data based on a comparison of the reconstruction error and a predefined threshold. Furthermore, the instructions loaded into the CPU 102 may comprise code to detect an anomaly responsive to the input being determined to comprise out-of-distribution data.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

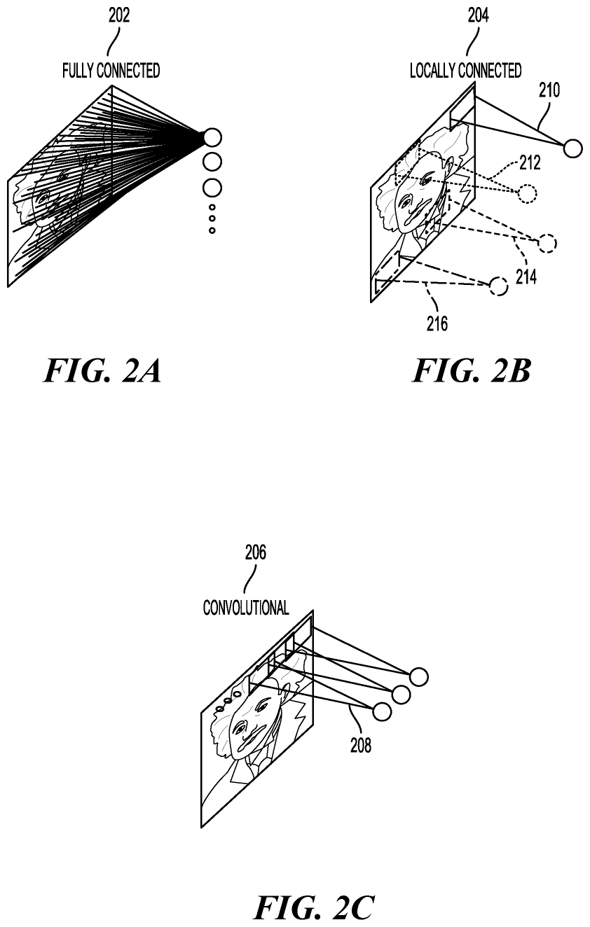

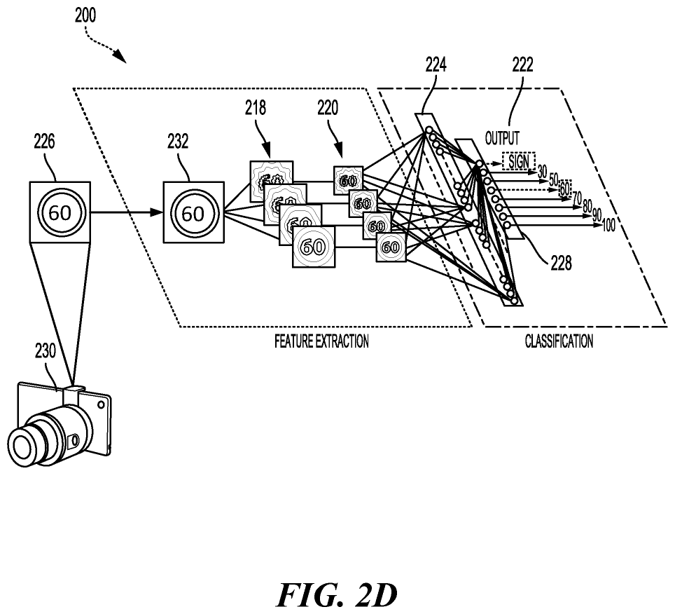

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

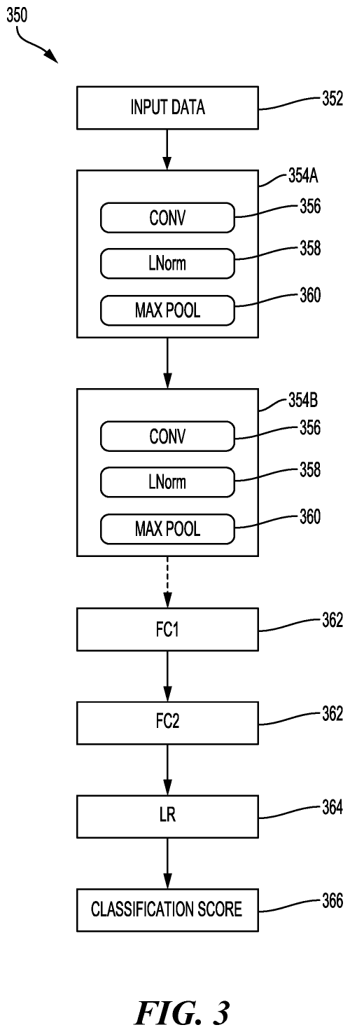

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

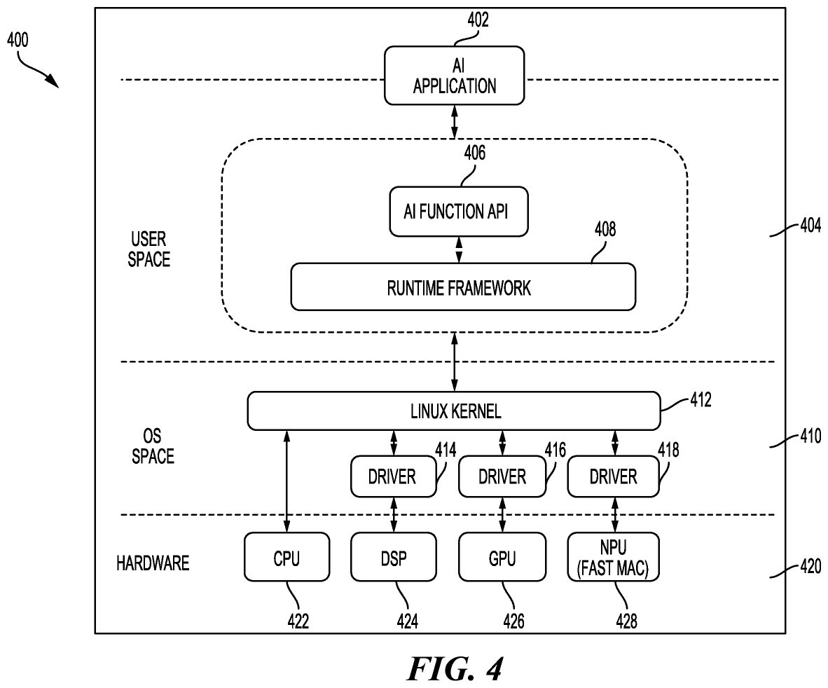

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428, if present.

According to certain aspects of the present disclosure, each of the fully connected layers 362 may be configured to determine parameters of the model based upon desired one or more functional features of the model, and develop the one or more functional features towards the desired functional features as the determined parameters are further adapted, tuned and updated.

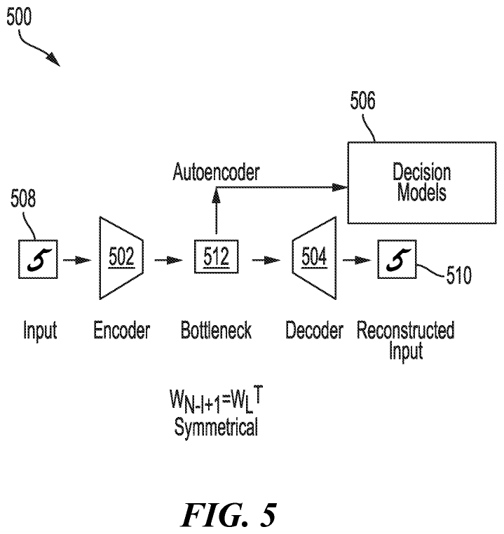

FIG. 5 is a diagram illustrating an example architecture 500 for an anomaly detection and decision model, in accordance with aspects of the present disclosure. Referring to FIG. 5, the example architecture 500 includes an encoder 502, a decoder 504, and a decision model 506. The encoder 502 and the decoder 504 may each be implemented as neural networks (e.g., deep convolutional network 350). The encoder 502 and decoder 504 may each include multiple convolutional layers or fully connected layers (e.g., FC1 362 shown in FIG. 3), for instance.

The encoder 502 may receive an input 508. As shown in FIG. 5, the input 508 may be an image, for example. However, the present disclosure is not so limiting and other types of inputs may also be received. For instance, the input 508 may also include medical diagnostic data, sensor data, financial transaction data, network monitoring data and other data types. The encoder 502 may process the input 508 to extract a set of features of the input 508. The encoder 502 may output a latent representation of the input 508. The latent representation may be supplied to the decoder 504. The decoder 504 may be configured to process the latent representation to generate a reconstruction 510 of the input 508.

In accordance with aspects of the present disclosure, the reconstruction 510 may be compared to the input 508 to compute a reconstruction error. The reconstruction error may serve as an anomaly score. For instance, the reconstruction error may be compared to a threshold value. If the reconstruction error is above the threshold, then the input 508 may be determined to be an outlier and out-of-distribution.

On the other hand, if the reconstruction error is below the threshold, then the input 508 may be determined to be in-distribution. In some aspects, responsive to determining that the input 508 is in-distribution, extracted features 512 of the input 508 may be supplied to the decision model 506 for further processing. For example, the processing may include classification, object detection, segmentation or other processing. In the example of FIG. 5, the decision model 506 may process the extracted features 512 to generate an inference, which may indicate that an object in the input 508 is the number five (5).

In some aspects, the weights of the layers of the encoder 502 may be tied or the same as the weights of the layers of the decoder 504. That is, the weights may be symmetrical such that the encoder 502 may share the same weights as the decoder 504. In doing so, the memory footprint of the encoder 502 and the decoder 504 may be reduced (e.g., halve the number of weights in the model). Additionally, because the model weights are tied, training time may be reduced and the risk of overfitting may be limited.

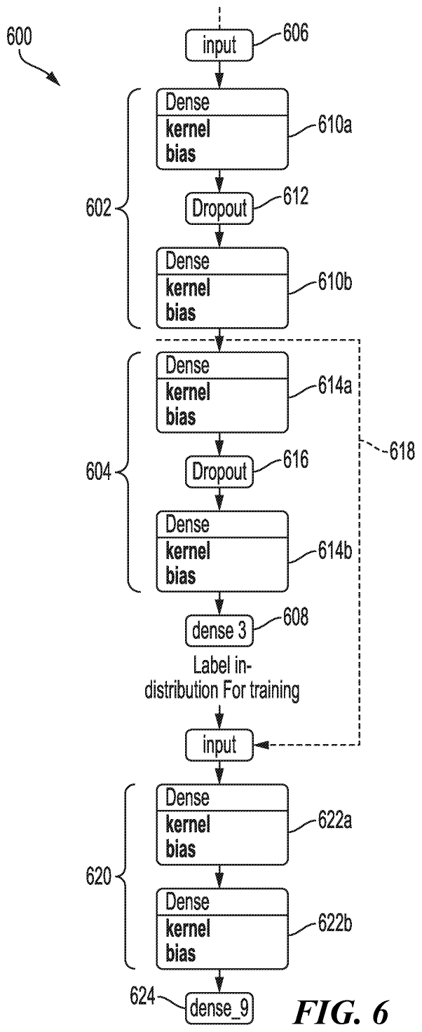

FIG. 6 is a block diagram illustrating another example architecture 600 for an anomaly detection and decision model, in accordance with aspects of the present disclosure. As shown in FIG. 6, the example architecture 600 includes an encoder 602, a decoder 604, and a decision model 620. The encoder 602 and the decoder 604 each include multiple dense or fully connected layers (e.g., 610a, 610b and 614a, 614b, respectively), such that the layers of the encoder 602 and decoder 604 are respectively connected in an all-to-all arrangement. A regularization layer (e.g., 612, 616) may also be provided between fully connected layers (e.g., 610a, 610b and 614a, 614b). For example, the regularization layer 612 of the encoder 602 may implement a dropout function to reduce overfitting. The dropout function may reduce overfitting by randomly turning off or dropping some nodes in a layer, for instance. The regularization layer 612 may modify the dimensions of the data. Because data movement is computationally expensive, rather than using raw data (e.g., having 120 dimensions), lower dimension data (e.g., having 16 dimensions) may be used. In doing so, a bottleneck in transmitting data output of the encoder 602 may be reduced.

The encoder 602 and the decoder 604 may be configured as an autoencoder. The encoder 602 may be trained according to a training dataset to receive an input 606 and to process the input 606 via the fully connected layers 610a and 610b to successively extract features of the input 606 to produce a latent representation 618 of the input 606. The latent representation 618 may be supplied to the decoder 604.

The decoder 604 may receive the latent representation 618. The decoder 604 may be trained to process the latent representation 618 in reciprocal fashion relative to the encoder 602. As such, the decoder 604 may process the latent representation 618 through successive dense layers 614a and 614b to generate a reconstruction 608 of the input 606.

A reconstruction error may be computed based on a comparison of the reconstruction 608 and the input 606. Notably, in the example of FIG. 6, by configuring the encoder 602 and decoder 604 with fully connected layers (e.g., 610a, 610b, 614a, and 614b), having all-to-all-connectivity, a reconstruction may be generated with greater precision as a tradeoff for computation speed. This may also impact the reconstruction error because the reconstruction error is increased for out-of-distribution data. Thus, the confidence in anomaly detection may be improved.

The reconstruction error may be compared to a threshold. In some aspects, the threshold may be one standard deviation of the mean average error (MAE) or one standard deviation of the mean square error (MSE), for example. In some aspects, the threshold may be varied to adjust the precision and recall of the model. For example, in a first time period, the threshold may be the mean average error from the training set. Then, in a second time period, the threshold may be a sum of the mean average error and the one standard deviation from the training set.

If the reconstruction error is greater than the threshold, then the input 606 may be determined to be out-of-distribution data. In turn, if the input 606 is determined to be out-of-distribution, then an anomaly may be detected. Accordingly, the input 606 may be saved as a training example.

Conversely, if the reconstruction error is less than the threshold, then the input may be determined to be in-distribution data. Accordingly, the latent representation 618 generated by the encoder 602 may be supplied as input to the decision model 620. In turn, the decision model 620 may process the received latent representation 618 via successive layer 622a and 622b to perform an inference task such as classification, object detection, or segmentation, for example. As shown in FIG. 6, the layers 622a and 662b are dense or fully connected layers. However, the present disclosure is not so limited and convolutional layers (e.g., 356 shown in FIG. 3) or the like may process the latent representation to perform the inference task indicated via output 624.

In some aspects, the encoder 602 may share weights with the decoder 604 to reduce memory footprint for the autoencoder (e.g., encoder 602, decoder 604). Additionally, using this tied weight arrangement may reduce the training time for the autoencoder, which may be trained via a greedy layer-wise process.

In some aspects, the example architecture 600 may be implemented with near-data computation on a system-on-a-chip (SoC) such as SoC 100 of FIG. 1, for example. For instance, in some examples, the autoencoder (e.g., encoder 602, decoder 604) may be deployed using lower computation in closer proximity to raw data, such as a DSP (e.g., DSP 106) or NPU (e.g., NPU 108). On the other hand, the decision model 620 may be deployed using higher computation devices such as a CPU (e.g., CPU 102) or GPU (e.g., GPU 104).

Additionally, on-device training such as transfer learning, fine-tuning, federated learning or personalization, for example, may also be deployed on higher computation devices (CPU, GPU).

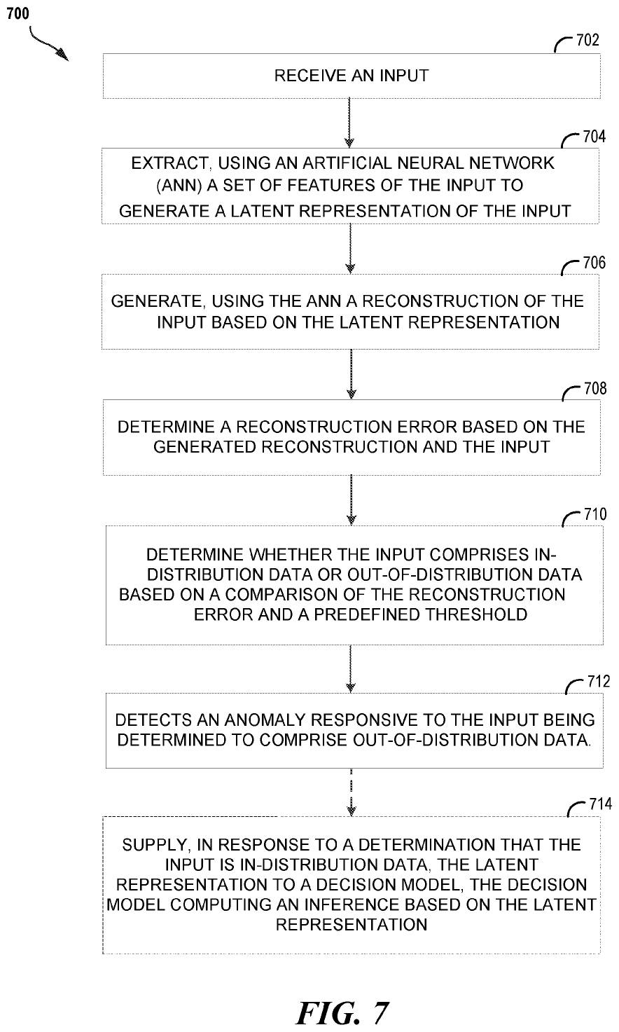

FIG. 7 is a flow diagram illustrating a method 700 of anomaly detection and energy-efficient inference determination, according to aspects of the present disclosure. In block 702, the method 700 receives an input.

At block 704, the method 700 extracts, using an artificial neural network (ANN), a set of features of the input to generate a latent representation of the input. As described, for instance, with reference to FIG. 6, the encoder 602 may be trained according to a training dataset to receive an input 606 and to process the input 606 via the fully connected layers 610a and 610b to successively extract features of the input 606 to produce a latent representation 618 of the input 606.

At block 706, the method 700 generates, using the ANN, a reconstruction of the input based on the latent representation. For example, as described with reference to FIG. 6, the decoder 604 may receive the latent representation 618. The decoder 604 may process the latent representation 618 through successive dense layers 614a and 614b to generate a reconstruction 608 of the input 606.

At block 708, the method 700 determines a reconstruction error based on the generated reconstruction and the input. For example, as described with reference to FIG. 6, a reconstruction error may be computed as the loss between the reconstruction 608 and the input 606.

At block 710, the method 700 determines whether the input comprises an anomaly or in-distribution data based on a comparison of the reconstruction error and a predefined threshold. For example, as described with reference to FIG. 6, the reconstruction error may be compared to a threshold. In some aspects, the threshold may be one standard deviation of the mean average error (MAE) or one standard deviation of the mean square error (MSE), for example. Additionally, in some aspects, the threshold may be varied to adjust the precision and recall of the model. For example, in a first time period, the threshold may be the mean average error from the training set. Then, in a second time period, the threshold may be a sum of the mean average error and the one standard deviation from the training set.

At block 712, the method 700 detects an anomaly responsive to the input being determined to comprise out-of-distribution data. As described with reference to FIG. 6, if the reconstruction error is greater than the threshold, then the input 606 may be determined to be out-of-distribution data. In turn, if the input 606 is determined to be out-of-distribution, then an anomaly may be detected. Accordingly, the input 606 may be saved as a training example, which may be used for further training the autoencoder (e.g., 602, 604).

In some aspects, at block 714, the method 700 may optionally supply, in response to a determination that the input is in-distribution data, the latent representation to a decision model. The decision model computes an inference based on the latent representation. As described, for instance, with reference to FIG. 6, if the reconstruction error is less than the threshold, then the input may be determined to be in-distribution data. Accordingly, the latent representation 618 generated by the encoder 602 may be supplied as input to the decision model 620. In turn, the decision model 620 may process the received latent representation 618 to perform an inference task such as classification, object detection, or segmentation, for example.

Implementation examples are provided in the following numbered clauses.
1. A processor-implemented method comprising:
   receiving an input;
   extracting, using an artificial neural network (ANN), a set of features of the input to generate a latent representation of the input;
   generating, using the ANN, a reconstruction of the input based on the latent representation;
   determining a reconstruction error based on the generated reconstruction and the input;
   determining whether the input comprises in-distribution data or out-of-distribution data based on a comparison of the reconstruction error and a predefined threshold; and
   detecting an anomaly responsive to the input being determined to comprise out-of-distribution data.
2. The processor-implemented method of clause 1, in which the predefined threshold comprises one of a mean average error, a mean square error, a standard deviation of a training data set or a combination thereof.
3. The processor-implemented method of clause 1 or 2, in which the predefined threshold is dynamically programmable.
4. The processor-implemented method of any of clauses 1-3, in which an encoder produces the latent representation of the input, a decoder generates the reconstruction of the input, and weight parameters of the encoder are shared with the decoder.
5. The processor-implemented method of any of clauses 1-4, further comprising saving, in response to detecting the anomaly, the out-of-distribution data to a training data set.
6. The processor-implemented method of any of clauses 1-5, further comprising supplying, in response to a determination that the input is in-distribution data, the latent representation to a decision model, the decision model computing an inference based on the latent representation.
7. The processor-implemented method of any of clauses 1-6, in which the extracting is performed via an encoder and the generating is performed via a decoder; and the encoder and the decoder are deployed via a digital signal processor or neural processing unit and the decision model is deployed via a central processing unit or a graphics processing unit.
8. An apparatus, comprising:
   A memory; and
   at least one processor coupled to the memory, the at least one processor being configured:
   to receive an input;
   to extract, using an artificial neural network (ANN), a set of features of the input to generate a latent representation of the input;
   to generate, using the ANN, a reconstruction of the input based on the latent representation;
   to determine a reconstruction error based on the generated reconstruction and the input;
   to determine whether the input comprises in-distribution data or out-of-distribution data based on a comparison of the reconstruction error and a predefined threshold; and
   detect an anomaly responsive to the input being determined to comprise out-of-distribution data.
9. The apparatus of clause 8, in which the predefined threshold comprises one of a mean average error, a mean square error, a standard deviation of a training data set or a combination thereof.
10. The apparatus of clause 8 or 9, in which the predefined threshold is dynamically programmable.
11. The apparatus of any of clauses 8-10, in which an encoder produces the latent representation of the input, a decoder generates the reconstruction of the input, and weight parameters of the encoder are shared with the decoder.
12. The apparatus of any of clauses 8-11, in which the at least one processor is further configured to save, in response to detecting the anomaly, the out-of-distribution data to a training data set.
13. The apparatus of any of clauses 8-12, in which the at least one processor is further configured to supply, in response to a determination that the input is in-distribution data, the latent representation to a decision model, the decision model computing an inference based on the latent representation.
14. The apparatus of any of clauses 8-13, in which the extracted set of features is produced via an encoder and the reconstruction is generated via a decoder, the encoder and the decoder are deployed via a digital signal processor or neural processing unit and the decision model is deployed via a central processing unit or a graphics processing unit.
15. An apparatus, comprising:
   means for receiving an input;
   means for extracting, using an artificial neural network (ANN), a set of features of the input to generate a latent representation of the input;
   means for generating, using the ANN, a reconstruction of the input based on the latent representation;
   means for determining a reconstruction error based on the generated reconstruction and the input;
   means for determining whether the input comprises in-distribution data or out-of-distribution data based on a comparison of the reconstruction error and a predefined threshold; and
   detecting an anomaly responsive to the input being determined to comprise out-of-distribution data.
16. The apparatus of clause 15, in which the predefined threshold comprises one of a mean average error, a mean square error, a standard deviation of a training data set or a combination thereof.
17. The apparatus of clause 15 or 16, in which the predefined threshold is dynamically programmable.
18. The apparatus of any of clauses 15-17, in which an encoder is used to produce the latent representation of the input, a decoder is used to generate the reconstruction of the input, and weight parameters of the encoder are shared with the decoder.
19. The apparatus of any of clauses 15-18, in which the encoder and the decoder are deployed via a digital signal processor or neural processing unit.
20. The apparatus of any of clauses 15-19, further comprising supplying, in response to a determination that the input is in-distribution data, the latent representation to a decision model, the decision model computing an inference based on the latent representation.
21. The apparatus of any of clauses 15-20, in which an encoder is used to extract the set of features and the a decoder is used to generate the reconstruction, the encoder and the decoder are deployed via a digital signal processor or neural processing unit and the decision model is deployed via a central processing unit or a graphics processing unit.
22. A non-transitory computer readable medium having encoded thereon program code, the program code being executed by a processor and comprising:
   program code to receive an input;
   program code to extract, using an artificial neural network (ANN), a set of features of the input to generate a latent representation of the input;
   program code to generate, using the ANN, a reconstruction of the input based on the latent representation;
   program code to determine a reconstruction error based on the generated reconstruction and the input; and
   program code to determine whether the input comprises in-distribution data or out-of-distribution data based on a comparison of the reconstruction error and a predefined threshold; and
   program code to detect an anomaly responsive to the input being determined to comprise out-of-distribution data.
23. The non-transitory computer readable medium of clause 22, in which the predefined threshold comprises one of a mean average error, a mean square error, a standard deviation of a training data set or a combination thereof.
24. The non-transitory computer readable medium of clause 22 or 23, in which the predefined threshold is dynamically programmable.
25. The non-transitory computer readable medium of any of clauses 22-24, in which an encoder produces the latent representation of the input, a decoder generates the reconstruction of the input, and weight parameters of the encoder are shared with the decoder.
26. The non-transitory computer readable medium of any of clauses 22-25, further comprising program code to save, in response to detecting the anomaly, the out-of-distribution data to a training data set.
27. The non-transitory computer readable medium of any of clauses 22-26, further comprising program code to supply, in response to a determination that the input is in-distribution data, the latent representation to a decision model, the decision model computing an inference based on the latent representation.
28. The non-transitory computer readable medium of any of clauses 22-27, further comprising program code to produce the extracted set of features via an encoder and program code to generate the reconstruction via a decoder, the encoder and the decoder are deployed via a digital signal processor or neural processing unit and the decision model is deployed via a central processing unit or a graphics processing unit.

In one aspect, the receiving means, the extracting means, generating means, means for determining a reconstruction and/or means for determining whether the input is an anomaly may be the CPU 102, program memory associated with the CPU 102, the GPU 104, the DSP 106, NPUs 108, the dedicated memory block 118, fully connected layers 362, and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving an input;
extracting, using an artificial neural network (ANN), a set of features of the input to generate a latent representation of the input;
generating, using the ANN, a reconstruction of the input based on the latent representation;
determining a reconstruction error based on the generated reconstruction and the input;
determining whether the input comprises in-distribution data or out-of-distribution data based on a comparison of the reconstruction error and a predefined threshold; and
detecting an anomaly responsive to the input being determined to comprise out-of-distribution data.

2. The processor-implemented method of claim 1, in which the predefined threshold comprises one of a mean average error, a mean square error, a standard deviation of a training data set or a combination thereof.

3. The processor-implemented method of claim 1, in which the predefined threshold is dynamically programmable.

4. The processor-implemented method of claim 1, in which an encoder produces the latent representation of the input, a decoder generates the reconstruction of the input, and weight parameters of the encoder are shared with the decoder.

5. The processor-implemented method of claim 1, further comprising saving, in response to detecting the anomaly, the out-of-distribution data to a training data set.

6. The processor-implemented method of claim 1, further comprising supplying, in response to a determination that the input is in-distribution data, the latent representation to a decision model, the decision model computing an inference based on the latent representation.

7. The processor-implemented method of claim 6, in which the extracting is performed via an encoder and the generating is performed via a decoder; and the encoder and the decoder are deployed via a digital signal processor or neural processing unit and the decision model is deployed via a central processing unit or a graphics processing unit.

8. An apparatus, comprising:
A memory; and
at least one processor coupled to the memory, the at least one processor being configured:
to receive an input;
to extract, using an artificial neural network (ANN), a set of features of the input to generate a latent representation of the input;
to generate, using the ANN, a reconstruction of the input based on the latent representation;
to determine a reconstruction error based on the generated reconstruction and the input;
to determine whether the input comprises in-distribution data or out-of-distribution data based on a comparison of the reconstruction error and a predefined threshold; and
detect an anomaly responsive to the input being determined to comprise out-of-distribution data.

9. The apparatus of claim 8, in which the predefined threshold comprises one of a mean average error, a mean square error, a standard deviation of a training data set or a combination thereof.

10. The apparatus of claim 8, in which the predefined threshold is dynamically programmable.

11. The apparatus of claim 8, in which an encoder produces the latent representation of the input, a decoder generates the reconstruction of the input, and weight parameters of the encoder are shared with the decoder.

12. The apparatus of claim 8, in which the at least one processor is further configured to save, in response to detecting the anomaly, the out-of-distribution data to a training data set.

13. The apparatus of claim 8, in which the at least one processor is further configured to supply, in response to a determination that the input is in-distribution data, the latent representation to a decision model, the decision model computing an inference based on the latent representation.

14. The apparatus of claim 13, in which the extracted set of features is produced via an encoder and the reconstruction is generated via a decoder, the encoder and the decoder are deployed via a digital signal processor or neural processing unit and the decision model is deployed via a central processing unit or a graphics processing unit.

15. An apparatus, comprising:
means for receiving an input;
means for extracting, using an artificial neural network (ANN), a set of features of the input to generate a latent representation of the input;
means for generating, using the ANN, a reconstruction of the input based on the latent representation;
means for determining a reconstruction error based on the generated reconstruction and the input;
means for determining whether the input comprises in-distribution data or out-of-distribution data based on a comparison of the reconstruction error and a predefined threshold; and
detecting an anomaly responsive to the input being determined to comprise out-of-distribution data.

16. The apparatus of claim 15, in which the predefined threshold comprises one of a mean average error, a mean square error, a standard deviation of a training data set or a combination thereof.

17. The apparatus of claim 15, in which the predefined threshold is dynamically programmable.

18. The apparatus of claim 15, in which an encoder is used to produce the latent representation of the input, a decoder is used to generate the reconstruction of the input, and weight parameters of the encoder are shared with the decoder.

19. The apparatus of claim 18, in which the encoder and the decoder are deployed via a digital signal processor or neural processing unit.

20. The apparatus of claim 15, further comprising supplying, in response to a determination that the input is in-distribution data, the latent representation to a decision model, the decision model computing an inference based on the latent representation.

21. The apparatus of claim 20, in which an encoder is used to extract the set of features and the a decoder is used to generate the reconstruction, the encoder and the decoder are deployed via a digital signal processor or neural processing unit and the decision model is deployed via a central processing unit or a graphics processing unit.

22. A non-transitory computer readable medium having encoded thereon program code, the program code being executed by a processor and comprising:
program code to receive an input;
program code to extract, using an artificial neural network (ANN), a set of features of the input to generate a latent representation of the input;
program code to generate, using the ANN, a reconstruction of the input based on the latent representation;
program code to determine a reconstruction error based on the generated reconstruction and the input; and
program code to determine whether the input comprises in-distribution data or out-of-distribution data based on a comparison of the reconstruction error and a predefined threshold; and
program code to detect an anomaly responsive to the input being determined to comprise out-of-distribution data.

23. The non-transitory computer readable medium of claim 22, in which the predefined threshold comprises one of a mean average error, a mean square error, a standard deviation of a training data set or a combination thereof.

24. The non-transitory computer readable medium of claim 22, in which the predefined threshold is dynamically programmable.

25. The non-transitory computer readable medium of claim 22, in which an encoder produces the latent representation of the input, a decoder generates the reconstruction of the input, and weight parameters of the encoder are shared with the decoder.

26. The non-transitory computer readable medium of claim 22, further comprising program code to save, in response to detecting the anomaly, the out-of-distribution data to a training data set.

27. The non-transitory computer readable medium of claim 22, further comprising program code to supply, in response to a determination that the input is in-distribution data, the latent representation to a decision model, the decision model computing an inference based on the latent representation.

28. The non-transitory computer readable medium of claim 27, further comprising program code to produce the extracted set of features via an encoder and program code to generate the reconstruction via a decoder, the encoder and the decoder are deployed via a digital signal processor or neural processing unit and the decision model is deployed via a central processing unit or a graphics processing unit.
